(19) United States
(12) Patent Application Publication
(10) Pub. No.: US 2009/0187899 A1
(43) Pub. Date: Jul. 23, 2009

(54) METHOD FOR INTELLIGENT PATCH SCHEDULING USING HISTORIC AVERAGES OF VIRTUAL I/O UTILIZATION AND PREDICTIVE MODELING

(75) Inventors: Anbazhagan Mani, Bangalore (IN); Robert G. Kovacs, Austin, TX (US); Morgan J. Rosas, Round Rock, TX (US); Vasu Vallabhaneni, Austin, TX (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/018,461

(22) Filed: Jan. 23, 2008

(51) Int. Cl. G06F 9/44

(52) U.S. Cl. 717/168

(57) ABSTRACT

A method for intelligent patch scheduling for a virtual (I/O) server is provided. Virtual I/O performance indicators of a virtual I/O server are monitored. The performance indicators are stored in a database. Historic averages of the performance indicators are maintained in the database. Patches to be applied to a client partition of the virtual I/O server are received. A reboot window is received for the client partition and is an allowed time frame for rebooting to apply the patches. Future virtual I/O utilization is predicted by running predictive modeling utilizing the historic averages of the performance indicators, and based on the predictive modeling, a specific time within the allowed time frame is determined for rebooting the client partition of the virtual I/O server to apply the patches. The virtual I/O server is rebooted to apply the patches to the client partition at the specific time within the reboot window.

### BACKGROUND

Exemplary embodiments relate to intelligent patch scheduling, and particularly to intelligent patch scheduling using historic averages and predictive modeling.

In computing systems, operating system patches (or fix packs) are required to be installed periodically to address software bugs, performance issues, or functionality improvements. Patching involves two phases. Phase I is to make the patch available to he installed. This can be done by two popular ways. The patch can be downloaded directly from the Internet to the system where the patch needs to be applied. Also, the patch can be downloaded offline and burned into physical media (e.g., a DVD or CDROM), or the patch can be shared from a corporate internal network. The media is inserted and provided to the system where the patch needs to be applied.

Phase II is to install the patch. Patch scheduling is a concept that is currently used in a variety of operating systems (e.g., Windows), applications (e.g., Adobe Acrobat), and other software (including gaming software).

In addressing Phase I issues of making patches available to install, patching online gaming software may include an approach for monitoring network bandwidth and intelligently scheduling downloads of patches during off-peak time.

### SUMMARY

A method for intelligent patch scheduling for a virtual input and output (I/O) server is provided in accordance with an exemplary embodiment. Virtual I/O performance indicators of a virtual I/O server are monitored. The performance indicators are stored in a database of the virtual I/O server. Historic averages of the performance indicators are maintained in the database. Patches to be applied to a client partition of the virtual I/O server are received. A reboot window is received for the client partition, and the reboot window is an allowed time frame for rebooting the virtual I/O server to apply the patches. Future virtual I/O utilization is predicted by running predictive modeling utilizing the historic averages of the performance indicators, and based on the predictive modeling, a specific time within the allowed time frame is determined for rebooting the client partition of the virtual I/O server to apply the patches. The client partition of the virtual I/O server is rebooted to apply the patches at the specific time within the reboot window.

Additional features and advantages are realized through the techniques of the exemplary embodiments. Other elements are described in detail herein and are considered a part of the claimed invention. For a better understanding of the exemplary embodiments with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the present disclosure are apparent from the following detailed description taken in conjunction with the accompanying drawings in which:

FIG. 1 illustrates a block diagram of a virtual I/O server having an intelligent patcher in accordance with exemplary embodiments;

FIG. 2 illustrates a method for intelligent patch scheduling in accordance with exemplary embodiments; and

FIG. 3 illustrates an example of a computer 300 having capabilities, which may be included in exemplary embodiments.

The detailed description explains the exemplary embodiments of the invention, together with advantages and features, by way of example with reference to the drawings.

### DETAILED DESCRIPTION

This disclosure addresses the problems in applying patches to a virtual input/output (I/O) server operating system. A virtual I/O server (VIOS) is a device that may be used in system machines to host networks and to provide storage for client partitions. Since client partitions are dependent on the VIOS to provide virtual networking and virtual disks, applying patches and rebooting the VIOS partition means the client partition will be affected. In cases where only one VIOS is hosting I/O, client partitions may need to be shut down. Although some patches do not require reboot, many patches, however, do require reboot.

On a highly secured customer environment running VIOS, most customers will not be provided direct access to the Internet for downloading patches from VIOS partitions. Often, patches are downloaded offline and burned into physical media (e.g., a DVD), or patches are stored in a secure network location within the corporate firewall and shared via the network file system (NFS). In applying patches in a VIOS environment, the issue is deciding when the patch is going to be actually installed and when the VIOS can be rebooted (thereby affecting the client partitions), which is addressed herein. Methods for downloading the patch or making it available (i.e., Phase I) to the VIOS can be implemented in many ways, as those skilled in the art will appreciate.

In a virtual I/O environment, redundant VIOS servers, load balancing, and fail-over mechanisms are used to avoid shutting down client partitions. By using fail-over for the virtual network and virtual storage, one of the VIOS partitions can be applied, patched, and rebooted. In case of failure or scheduled shutdown of one of the VIOS servers, the other VIOS will continue to host I/O to the client partitions. The other advantage of redundant VIOS server by using load balancing is that virtual I/O operations can be evenly spread among multiple VIOS servers, thereby maximizing performance.

Many customers use redundant VIOS servers to manage fail-over scenarios, but there may be several limitations as apparent in the following problem scenario. Assume that VIOS1 and VIOS2 are the two VIOS partitions on a system and that there are three client partitions running AIX and Linux operating systems. Assume that a virtual disk (BackingDevice1) is configured on VIOS1 and a virtual disk (BackingDevice2) is configured on VIOS2. Also, assume that an AIX client partition (AIX1) is utilizing hosted storage on a storage area network (SAN) via load balancing (using round robin scheduling) provided by the two backing devices on VIOS1 and VIOS2. Further, assume that a patch is being applied on VIOS1, and as a result VIOS1 needs to be rebooted.

Using a multi-path I/O (MPIO) fail-over mechanism when VIOS1 is shut down for rebooting, it is possible that (using VIOS2) the client partition can still access the virtual disk by using the alternate path (assuming MPIO is correctly configured with two active paths). However, there are potential problems: (1) During peak I/O time periods where a lot of disk I/O is occurring, having only one VIOS partition (VIOS1) running (effectively reduced to a single path to storage) could significantly affect virtual I/O performance. (2) Similarly, in a networking scenario using shared Ethernet adapter (SEA) fail-over with SEA1 running on VIOS1 and SEA2 running on VIOS2 during a peak network traffic period, it is possible that the SEA1 running on VIOS1 can exceed the network capacity of the SEA1. Therefore, client partitions may suffer from performance problems, as only one VIOS server (VIOS1) is now bridging the traffic.

According to exemplary embodiments, a technique is provided to intelligently schedule application and/or installation of patches and to manage reboots even when redundant VIOS and fail-over techniques are used. Patches can be submitted to a new “Intelligent Patcher” module. The intelligent patcher may monitor virtual I/O operations and measure several key performance indicators, such as TCP/IP packets being transferred and the number of virtual disk reads, disk writes, and files opened. By maintaining historic averages for utilization of the virtual I/O and by using advanced learning based predictive modeling, the intelligent patcher may decide what is the best time in a given window to install the patch and to reboot the VIOS. By automatically finding out the best time to reboot, client partitions will be least affected. Therefore, the virtual I/O server environment is able to achieve its goals of providing the best performance and load balancing.

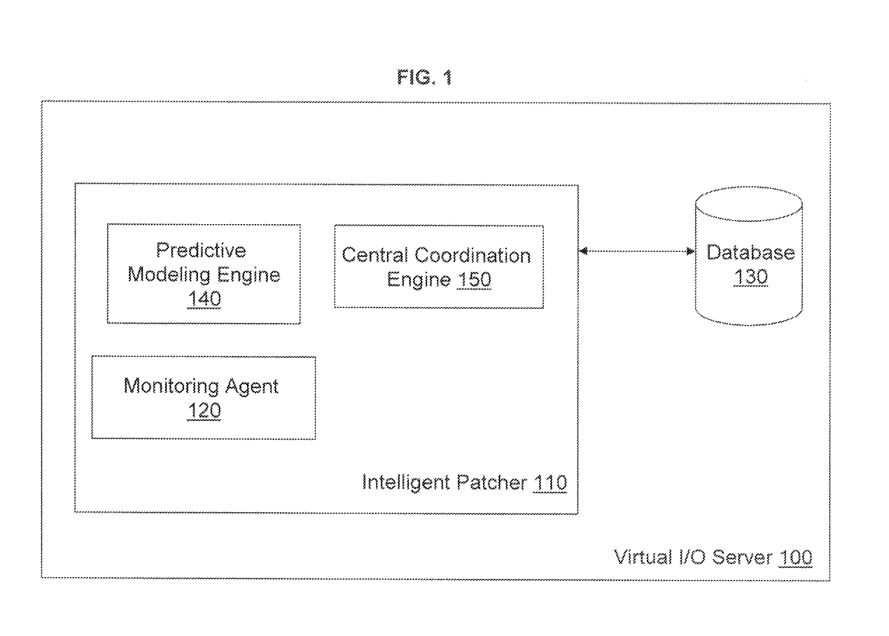

Now turning to FIG. 1, a block diagram illustrates a virtual I/O server 100 having an intelligent patcher in accordance with exemplary embodiments. FIG. 1 illustrates the virtual I/O server (VIOS) 100 comprising an intelligent patcher 110. As non-limiting examples, the intelligent patcher 110 may be an application, agent, and/or module. The intelligent patcher 110 may be integrated with or operatively connected to a continuous monitoring agent 120 configured to monitor key virtual I/O performance indicators. These performance indicators are numerous and may include the number of IP packets and the number of bytes transferred for virtual disk reads, disk writes, etc. In the virtual I/O server 100, a plurality of client partitions may be configured and each of the client partitions may be monitored by the monitoring agent 120 such that the intelligent patcher 110 functions as disclosed in exemplary embodiments. Although illustrations and non-limiting examples are discussed with regard to the virtual I/O server 100, it is understood that many client partitions may be configured on the virtual I/O server 100 and that the virtual I/O server 100 comprises the software and hardware for implementing and operating the client partitions.

The intelligent patcher 110 may be integrated with or operatively connected to a database 130 for storing the history of the utilization of the VIOS 100 (including each respective client partition) by storing the performance indicators. The monitoring agent 120 monitors and reads the virtual I/O utilization data. The database 130 also maintains historic averages of virtual I/O utilization of the VIOS 100. Using the historic averages of virtual I/O utilization, the intelligent patcher 110 is configured to provide information about virtual I/O utilization. As non-limiting examples, the following query can be run against the intelligent patcher 110:
What time of the day is the least number of disk writes performed by client partitions on the VIOS?
What time of the week is the least number of IP packets bridged by a shared Ethernet adapter on VIOS?
What time of the month is the least number of disk writes performed?

When applying patches, network administrators may submit patches (e.g., file sets) to the intelligent patcher 110. Also, for patches requiring reboots, network administrators may indicate a particular reboot window. A reboot window may specify the maximum time the intelligent patcher 110 can take to reboot the partition after successfully installing the patch. As a non-limiting example, a reboot window could be specified in minutes, hours, days, or months. As a non-limiting example, given a reboot window of 1 week, the intelligent patcher 110 can determine what is the best time within the 1 week to apply the patch and to reboot. As a non-limiting example, in the VIOS 100, the intelligent patcher may determine that one client partition of the plurality of client partitions can be rebooted a 7:00 on Monday, while the other client partitions are not rebooted on the VIOS 100. In exemplary embodiments, the network administrator's job of providing a path for the patch files and specifying the reboot window can be automated (e.g., by using scripts) or performed by other system management utilities. Although most patches take only a few minutes (e.g., 2-5 minutes typically) to install, if the patches require more than a few minutes to install, network administrators may also indicate approximately how long the patch will require to be installed.

Once the reboot window and the patches are specified, the intelligent patcher 110 may utilize the following mathematical models to find the best time to apply patches and to reboot. In exemplary embodiments, the intelligent patcher 110 may utilize historic averages of virtual I/O utilization (of the respective client partitions) as a means of identifying the best time to apply patches and reboot. Even though historic averages of virtual I/O utilization is maintained in the database 130, to deterministically calculate current or future virtual I/O utilization in a dynamic environment, learning based predictive modeling may also be run by a predictive modeling engine 140. The predictive modeling engine 140 of the intelligent patcher 110 can support simple through advanced learning based predictive modeling processes. The predictive modeling engine 140 is capable of implementing various models, and the models can be made available as plugins. Naive Bayes classifier called Bayes algorithm (simple), K-nearest neighbor algorithm (intermediate), and support vector machine (advanced) are non-limiting examples of predictive models that may be run by the predictive modeling engine 140 for predictive modeling

In exemplary embodiments, based on the predictive models run by the predictive modeling engine 140 and given a particular reboot window, the intelligent patcher 110 can determine the best time to apply patches and to reboot. Using this approach, client partitions may enjoy maximum performance of virtual I/O operations even when redundant virtual I/O servers (like VIOS 100) are used for load balancing and failover in accordance with exemplary embodiments. In the intelligent patcher 110, the various functions and activities may be controlled by a central coordination engine 150.

Moreover, by utilizing a client partition's virtual I/O historic utilization (on VIOS 100) and by performing predictive modeling to determine the best time within the reboot window in such a way that the client partition's performance is least impacted, an intelligent system is provided in accordance with the exemplary embodiment.

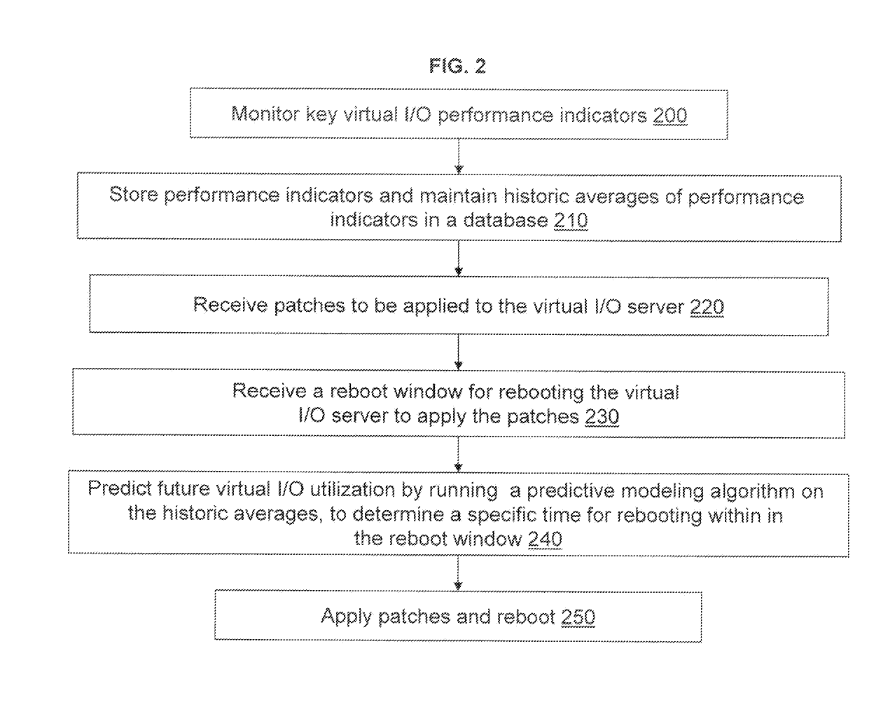

FIG. 2 illustrates a method for intelligent patch scheduling in accordance with exemplary embodiments. Key virtual I/O performance indicators are monitored at 200. The performance indicators respectively correspond to a plurality of client partitions of the virtual I/O server 100, and also, the performance indicators may be monitored for the entire virtual I/O server 100. The performance indicators may be stored in the database 130 of the virtual I/O server 100, and historic averages of the performance indicators may be maintained in the database 130 at 210. Patches to be applied to the virtual I/O server 100 are received at 220. As a non-limiting example, the patches may be downloaded from a server of an enterprise, and/or the patches may be uploaded from a recorded medium (such as a CD, flash drive, etc.). There may be different patches that respectively correspond to the client partitions of the virtual I/O server 100.

A reboot window for rebooting (a client partition of) the virtual I/O server 100 is received from, e.g., a network administrator, at 230. The reboot window is a time frame that is allowed for rebooting the virtual I/O server 100 to apply the patches for client partitions. As a non-limiting example, the reboot window may he a time period of one week (a day, a month, a certain amount of days, etc.), and the reboot may be allowed to occur within that week.

Future virtual I/O utilization (of the client partitions) is predicted by running predictive modeling utilizing the historic averages of the performance indicators (corresponding to the client partitions), and based on the predictive modeling, a specific time within the reboot window (e.g., of one week) is determined for rebooting the virtual I/O server 100 to apply the patches at 240. As a non-limiting example, the network administrator may input next week as the time frame in which a reboot may occur, and predictive modeling is performed to determine the best time (within the reboot window) next week for the reboot to take place. As a non-limiting example, based on predictive modeling, the best time for rebooting (a client partition of) the virtual I/O server 100 within the reboot window may be, e.g., at approximately 9:00 p.m. on Wednesday. The (client partition of) virtual I/O server 100 is rebooted at the specific time within the reboot window to apply the patches at 250.

In accordance with exemplary embodiments, a non-limiting example of a predictive modeling algorithm to find out whether reboot can happen based on historical data is provided below. A sample data set is provided in Table 1 of the average I/O utilization percentage, the time period, and whether a previous reboot has occurred in that range.

TABLE 1

| | Average I/O | | |
|---|---|---|---|
| | Utilization | | |
| | Percentage | Time Window | Previously |
| No. | Type | Origin | Rebooted |
| 1 | 0-20 | 06-09 hrs | YES |
| 2 | 20-40 | 09-12 hrs | NO |
| 3 | 40-60 | 06-09 hrs | NO |
| 4 | 20-40 | 21-24 hrs | YES |
| 5 | 0-20 | 06-09 hrs | YES |
| 6 | 80-100 | 18-21 hrs | NO |
| 7 | 20-40 | 21-24 hrs | YES |
| 8 | 40-60 | 04-06 hrs | NO |

In the non-limiting example, the Naïve Bayes predictive modeling algorithm is used to select the most likely outcome (classification) based on the training data set presented in the above Table 1. The classification is:

$${V}_{nb} = arg {max}_{{v}_{j} ∈ v} P ( {v}_{j} ) \prod P ( {a}_{i} \vert {v}_{j} ) \qquad Equation ( 1 )$$

In Equation (1), we generally estimate P(αᵢ|ν j) using m-estimates.

$$P ( {a}_{i} \vert vj ) = \frac{{n}_{c} + m p}{n + m} \qquad Equation ( 2 )$$

The following variable are defined:
n=the number of training examples for which v=νⱼ;
n_{c}=number of examples for which v=νⱼ and a=αᵢ;
p=a priori estimate for P(aᵢ|ν j);
m=the equivalent sample size;
αᵢ=Average I/O Utilization Percentage or Time Window; and
νⱼ=YES or NO.

From Table 1, possible values of αᵢ are 0-20, 20-40, 40-60, 60-80, 80-100 (I/O Utilization Percentage), and possible values of αᵢ is 0-3, 3-6, 6-9, 9-12, 12-15, 15-18, 18-21, 21-24 (Time window in hours).

Now assume that the problem is to find whether we can reboot when the current I/O utilization percentage is between 20-40 and current time window is 06-09. So to and the solution, we have to find the probabilities of the following:
P (20-40|YES), P(06-09|YES) and
P(20-40|NO), P(06-09|NO)

and then multiply them by P(YES) and P(NO) respectively.

We can estimate the values by using Equation (2) above in which:
n=4 (Number of times reboot have happened);
p=⅕ (Number of possible values for I/O Utilization is 5) or p=⅛ (Number of possible values for Time Period window is 8); and
m=3. Our m value is arbitrary, but consistent.

Further, we calculate;

P (20-40|YES)=(2+3*0.2)/(4+3)=0.37 (rounded to 2 digits);

P(06-09|YES)=(2+3*0.125)/(4+3)=0.34 (rounded to 2 digits);

P(20-40|NO)=(1+3*0.2)/(4+3)=0.23 (rounded to 2 digits); and

P(06-09|NO)=(1+3*0.125)/(4+3)=0.20 (rounded to 2 digits).

For the reboot to happen, the probability is P(YES)*P (20-40|YES)*P(06-09|YES), which is 0.5*0.37*0.34=0.0629.

For reboot not to happen, the probability is P(NO)*P(20-40|NO)*P(06-09|NO), which is 0.5*0.23*0.20=0.023.

Since 0.0629>0.023, the non-limiting example for the predictive algorithm indicates that a reboot can happen based on the sample data for the average I/O utilization of 20% to 40% in the time period between 06 hours to 09 hours.

The non-limiting example above has been discussed in detail but is not meant to be limiting in any way. It is understood that the non-limiting example above is for explanation purposes only.

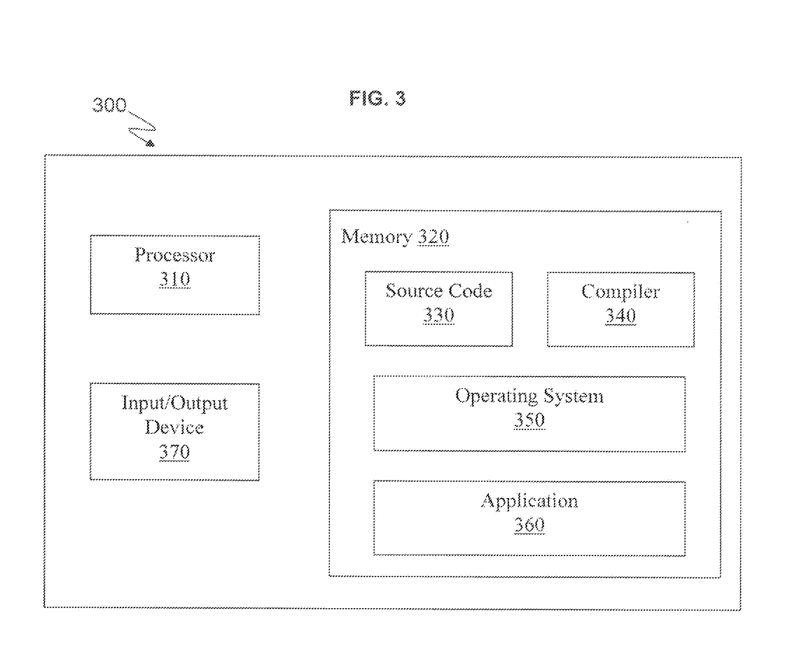

Referring back to FIG. 1, it is understood that the virtual I/O server 100 includes all the necessary software and hardware to operate as a server, including one or more processors and memory. The virtual I/O server 100 also includes software applications for operating a plurality of client partitions in accordance with exemplary embodiments. Further, client partitions (and their corresponding functionality) in the virtual I/O server 100 are understood by those skilled in the art. Although the intelligent patcher 110 is described with respect to the virtual I/O server 100, it is contemplated that the exemplary embodiment can be implemented in other computing devices. FIG. 3 illustrates an example of a computer 300 having capabilities, which may be included in exemplary embodiments. Various methods discussed above may also utilize the capabilities of the computer 300. One or more of the capabilities of the computer 300 may be incorporated in the virtual I/O server 100 and/or any element discussed herein.

The computer 300 includes, but is not limited to, workstations, servers, and the like. Generally, in terms of hardware architecture, the computer 300 may include one or more processors 310, memory 320, and one or more input and/or output (I/O) devices 370 that are communicatively coupled via a local interlace (not shown). The local interlace can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 310 is a hardware device for executing software that can be stored in the memory 320. The processor 310 can be virtually any custom made or commercially available processor, a central processing unit (CPU), a data signal processor (DSP), or an auxiliary processor among several processors associated with the computer 300, and the processor 310 may be a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Spare microprocessor from Sun Microsystems, Inc, a PA-RISC series microprocessor from Hewlett-Packard Company, U.S.A., or a 68______ series microprocessor from Motorola Corporation. U.S.A.

The memory 320 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 320 may incorporate electronic, magnetic, optical, and/or other types of storage media. Note that the memory 320 can have a distributed architecture, where various components are situated remote from one another, but can be accessed by the processor 310.

The software in the memory 320 may include one or more separate programs, each of which comprises an ordered listing of executable instructions for implementing logical functions. The software in the memory 320 includes at least one suitable operating system (O/S) 350, compiler 340, and source code 330, along with an application 360 (which may be one or more applications) in accordance with exemplary embodiments. As illustrated, the application 360 comprises numerous functional components for implementing the features and operations of the exemplary embodiments. The application 360 of the computer 300 may represent the various applications referred to herein, but the application 360 is not meant to be a limitation. In accordance with exemplary embodiments, the application 360 may include the intelligent patcher 110, the monitoring agent 120, the predictive modeling engine 140, the central coordination engine 150, and/or the application 360 may include configurations for implementing the same. The memory 320 may include the database 130 in accordance with exemplary embodiments.

A non-exhaustive list of examples of suitable commercially available operating systems 350 is as follows (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a Linux operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 350 essentially controls the execution of other computer programs, and provides scheduling, input-output control, file and data management, memory management, and communication control and related services. It is contemplated by the inventors that the application 360 for implementing exemplary embodiments is applicable on all other commercially available operating systems.

The application 360 may be a source program, executable program (object code), script, or any other entity comprising a set of instructions to be performed. When a source program, then the program is usually translated via a compiler (such as the compiler 340), assembler, interpreter, or the like, which may or may not be included within the memory 320, so as to operate properly in connection with the O/S 350. Furthermore, the application 360 can be written as (a) an object oriented programming language, which has classes of data and methods, or (b) a procedure programming language, which has routines, subroutines, and/or functions, for example but not limited to, C, C++, C#, Pascal BASIC, API calls, HTML, XHTML, XML, ASP scripts, FORTRAN, COBOL, Perl, Java, ADA, .NET, and the like.

The I/O devices 370 may include input devices such as, for example but not limited to, a mouse, keyboard, scanner, microphone, camera, etc. Furthermore, the I/O devices 370 may also include output devices, for example hat not limited to, a printer, display, etc. The I/O devices 370 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 370 also include components and adapters for communicating over various networks.

If the computer 300 is a PC, server, workstation, intelligent device or the like, the software in the memory 320 may further include a basic input output system (BIOS) (omitted for simplicity). The BIOS is a set of essential software routines that initialize and test hardware at startup, start the O/S 350, and support the transfer of data among the hardware devices. The BIOS is stored in some type of read-only-memory, such, as ROM, PROM, EPROM, EEPROM or the like, so that the BIOS can be executed when the computer 300 is activated.

When the computer 300 is in operation, the processor 310 is configured to execute software stored within the memory 320, to communicate data to and from the memory 320, and to generally control operations of the computer 300 pursuant to the software. The application 360 and the O/S 350 are read, in whole or in part, by the processor 310, perhaps buffered within the processor 310, and then executed.

When the application 360 is implemented in software it should be noted that the application 360 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 360 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 360 is implemented in hardware, the application 360 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It is understood that the computer 300 includes non-limiting examples of software and hardware components that may be included in various devices and systems discussed herein, and it is understood that additional software and hardware components may be included in the various devices and systems discussed in exemplary embodiments.

The capabilities of the exemplary embodiment can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depleted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While exemplary embodiments to the invention have been described, it will be understood that those skilled in the art, both now and in the future, may make various improvements and enhancements which fall within the scope of the claims which follow. These claims should be construed to maintain the proper protection for the invention first described.

1. A method for intelligent patch scheduling for a virtual input and output (I/O) server comprising:
monitoring virtual I/O performance indicators of a virtual I/O server;
storing the performance indicators in a database of the virtual I/O server;
maintaining historic averages of the performance indicators in the database;
receiving patches to be applied to a client partition of the virtual I/O server;
receiving a reboot window for the client partition, wherein the reboot window is an allowed time frame for rebooting the virtual I/O server to apply the patches;
predicting future virtual I/O utilization by running predictive modeling utilizing the historic averages of the performance indicators, wherein based on the predictive modeling, a module determines and selects a specific time within the allowed time frame for rebooting the client partition of the virtual I/O server to apply the patches;
wherein predictive modeling comprises:
selecting a utilization range from a plurality of utilization ranges for the virtual I/O server;
selecting a time window from a plurality of time windows for the virtual I/O server;
by utilizing the historic averages of the performance indicators, determining a probability that the virtual I/O server should be rebooted during the selected utilization range and determining a probability that the virtual I/O server should be rebooted during the selected time window;
to equal a total YES probability, combining the probability that the virtual I/O server should be rebooted during the selected utilization range with the probability that the virtual I/O server should be rebooted during the selected time window;
by utilizing the historic averages of the performance indicators, determining a probability that the virtual I/O server should not be rebooted during the selected utilization range and determining a probability that the virtual I/O server should not be rebooted during the selected time window;
to equal a total NO probability, combining the probability that the virtual I/O server should not be rebooted during the selected utilization range with the probability that the virtual I/O server should not be rebooted during the selected time window; and
comparing the total YES probability to the total NO probability; and
rebooting the client partition of the virtual I/O server to apply the patches at the specific time within the reboot window, responsive to the total YES probability being greater than the total NO probability.

2. The method of claim 1, wherein the reboot window comprises at least one of minutes, hours, days, and months.

3. The method of claim 1, wherein the virtual I/O performance indicators relate to a plurality of client partitions of the virtual I/O server; and
wherein the virtual I/O performance indicators comprise at least one of a number of Internet protocol packets, a number of bytes transferred for virtual disk reads, a number of disk writes, and a number of files opened.
